(19) United States
(12) Patent Application Publication
(10) Pub. No.: US 2010/0273905 A1
(43) Pub. Date: Oct. 28, 2010

(54) THERMOPLAST-CONTAINING EPOXY RESINS AND THE PROCESSING THEREOF BY EXTRUSION OR INJECTION MOLDING

(75) Inventor: Xaver Muenz, Heidelberg (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/817,401

(22) Filed: Jun. 17, 2010

Related U.S. Application Data
(63) Continuation of application No. PCT/EP2008/059536, filed on Jul. 21, 2008.

(30) Foreign Application Priority Data
Dec. 19, 2007 (DE) 102007061860.5

(51) Int. Cl. C08J 9/00; C08L 63/00

(52) U.S. Cl. 521/135; 525/409; 156/293

(57) ABSTRACT

The invention relates to a material mixture comprising at least one epoxy resin and a thermoplast, selected from such copolymers that comprise at least three different monomers. Preferably, the thermoplast is selected from such where at least one monomer is a hydrocarbon without heteroatoms and with at least one C═C double bond and where at least one other monomer is an optionally substituted acrylate or an optionally substituted acrylic acid ester. The invention also relates to a material mixture of said kind that additionally comprises the following components: at least one blowing agent, at least one hardener and at least one filler. The invention relates to methods for the production of molded bodies made from said material mixture, to the molded bodies and the use thereof for structural reinforcement.

### CROSS-REFERENCE TO RELATED CASES

This application is a continuation under 35 U.S.C. Sections 365(c) and 120 of International Application No. PCT/EP2008/059536, filed Jul. 21, 2008 and published on Jun. 25, 2009 as WO 2009/077212, which claims priority from German Patent Application Serial No. 10 2007 061 860.5 filed Dec. 19, 2007, which are incorporated herein by reference in their entirety.

### TECHNICAL FIELD

The present invention relates to epoxy resin/thermoplastic blends which are in particular suitable for manufacturing injection moldings which are slightly tacky or non-tacky. These injection moldings are preferably thermally expandable and are suitable for the structural bracing of components, in particular for vehicle construction. The present invention here encompasses the substance mixture, a method for producing moldings from this substance mixture and the use thereof for structural bracing.

### BACKGROUND OF THE INVENTION

There is a need in many fields of application for lightweight components for consistently dimensionally stable mass production having elevated rigidity and structural strength. In particular in vehicle construction, due to the weight savings desired in this field, there a major requirement for lightweight components produced from thin-walled structures which nevertheless exhibit sufficient rigidity and structural strength. One route to achieving elevated rigidity and structural strength combined with the lowest possible weight of the component makes use of hollow parts which are fabricated from relatively thin sheet metal or plastics sheet. Thin-walled sheet metal does, however, have a tendency to deform easily. It has accordingly already been known for some time to fill the cavity of hollow body structures with a structural foam, whereby on the one hand deformation or distortion is prevented or minimized and on the other hand the strength and rigidity of these parts are increased.

Such foamed reinforcement and bracing systems are conventionally either metal foams or they contain a thermally curable resin or binder, such as for example epoxy resins. These compositions generally contain a blowing agent, fillers and reinforcing fillers such as for example hollow glass microspheres. In the foamed and cured state, such foams preferably have a density of 0.3 to 0.7 g/cm³. After curing, these foams are intended to be capable of withstanding temperatures of above 130° C., preferably of above 150° C., for at least short periods without suffering damage. Such foamable, thermally curable compositions generally contain further components, such as curing agents, processing auxiliaries, stabilizers, dyes or pigments, optionally UV absorbers and adhesion-promoting components.

WO 96/37400 describes a W-shaped reinforcing structure, which contains a thermally expandable, resinous material and is introduced into the hollow article to be reinforced before curing. The reinforcing polymeric matrix preferably consists of a single-component, pasty system containing an epoxy resin, an acrylonitrile/butadiene rubber, fillers, high strength glass beads, a curing agent and an accelerator and a blowing agent based on an azo compound or a hydrazide compound.

WO 00/27920 discloses expandable sealing and damping compositions, which are blends of one thermoplastic resin or a plurality of thermoplastic resins and an epoxy resin. These are intended to be injection-moldable and lightweight and to have a high compressive strength. The following examples of thermoplastic resins may be mentioned: solid rubbers such as styrene/butadiene rubbers and nitrile/butadiene rubbers or polystyrene polymers such as for example SBS block copolymers. The epoxy resin is preferably liquid.

WO 00/52086 proposes the production of heat-curable, thermally expandable moldings from a blend consisting of at least one solid reactive resin, at least one liquid reactive resin and at least one flexibilizing reactive resin together with curing agents and/or accelerators or blowing agents. These moldings are suitable for bracing and/or reinforcing thin-walled metal structures and for bracing hollow metallic lightweight constructions. The moldings according to the teaching of this document are distinguished relative to known heat-curable, thermally expandable moldings by improved dimensional stability in the uncured state and by slight surface tackiness. The characteristics of processability and dimensional stability are achieved by mixing epoxy resins with different melting points. However, the reduced surface tackiness may only ever be achieved within a very narrow temperature range, such that a formulation which, while tack-free in winter, however exhibits a very tacky surface in the summer. Furthermore, this procedure requires the use of large quantities of expensive resins and curing systems. Difficulties with manufacture and handling repeatedly arise in particular with regard to the inexpensive production of such expandable moldings by injection molding and this is undesirable for the process reliability of the manufacturing method.

German patent application DE 102006048739, which is not a prior publication, describes binders for the production of expandable, thermally curable moldings, which contain

at least one epoxy resin,
at least one polyester which is solid at room temperature,
at least one blowing agent,
at least one curing agent and
at least one filler.

“Flexibilizing agents” may additionally be included. Solid rubbers are stated as examples of flexibilizing agents. Examples of suitable solid rubbers are polybutadiene, styrene/butadiene rubber, butadiene/acrylonitrile rubber, EPDM, synthetic or natural isoprene rubber, butyl rubber or polyurethane rubber. Partially crosslinked solid rubbers based on isoprene/acrylonitrile or butadiene/acrylonitrile copolymers are particularly suitable.

These days, three-dimensional parts made from structural foams are usually produced by injection molding. Because of the tackiness of the materials at temperatures of above 30° C., the starting material for parts production using the injection molding method cannot be used in granule form. In order nevertheless to be able to produce parts by this method, costly modifications have to be made to the material feed system to the injection molding machine. A special feed system is necessary and it is therefore impossible to produce parts on any desired conventional commercial injection molding machines.

If formulations with a relatively high melting point are used to increase the softening point to approx. 40° C., the structural foam part has to be processed in the injection molding machine at relatively high temperatures in order to fill the molds. Temperatures of over 100° C. are not admissible, since otherwise the curing reaction of the composition is initiated and this may cause a blockage in the machine.

The high viscosity at temperatures just above the melting point of the epoxy resins and particularly the tackiness of the liquefied epoxy resins mean that the production of injection moldings is possible only with very great difficulty and considerable technical effort. This generally makes it necessary to fit special equipment on the processing machines and therefore increases capital costs.

The internal tackiness of the molten molding compound severely impairs flow behavior in the injection molding machine and the injection molds. The tackiness, of the hot epoxy resin-based injection molding compound may lead to soiling of the installations and thereby significantly increase maintenance and cleaning costs. Release agents may be used to remedy this. However, these may lead to corrosion of tools and machinery, which in turn increases maintenance requirements.

### SUMMARY OF THE INVENTION

An object of the present invention is to provide epoxy resin-based injection molding compounds in which the above-stated problems do not occur or occur only to a markedly reduced extent.

This object is achieved by adding suitable thermoplastics to the epoxy resin blend. It is known that thermoplastics have an elasticizing effect on epoxy resins. The present invention is based on the recognition that specific thermoplastics markedly reduce the tackiness of the epoxy resin melt or blend and lessen or completely prevent the possibility of machine components sticking together. This may even go so far as to its being possible to dispense completely with the use of release agents for such blends. By reducing the tackiness of the injection molding compound, flow behavior during the injection process is markedly improved. This leads to improved filling of the mold, to a reduction in cycle time and thus to a reduction in production costs. Due to the reduced tackiness, it is possible to dispense with special packaging for protecting the finished parts. Through suitable selection of the thermoplastics, the hardness of the solidified injection molding may be adjusted such that even bulk material is possible (in particular for small parts).

### DESCRIPTION OF THE INVENTION

The present invention accordingly relates to a substance mixture containing a polymer blend which contains at least one epoxy resin and one or more thermoplastics, wherein the thermoplastics are selected from those copolymers which contain at least three different monomers, and wherein the proportion by weight of the thermoplastics in the entire substance mixture is in the range from 0.5 to 40 wt. %.

Thermoplastics which are particularly suitable for this purpose are those which are selected from those in which at least one monomer is a hydrocarbon without heteroatoms and with at least one C═C double bond and at least one other monomer is an optionally substituted acrylate or an optionally substituted acrylic acid ester. Suitable thermoplastics may in particular be selected from the following copolymers: styrene/butadiene/(meth)acrylate, styrene/butadiene/(meth)acrylic acid ester, ethylene/(meth)acrylic acid ester/glycidyl(meth)acrylic acid ester, ethylene/(meth)acrylic acid ester/maleic anhydride, which may in each case assume the form of random copolymers or block copolymers.

In this case, the prefix “(meth)” before “acrylate” means, as usual, that these monomers may be both acrylate or acrylic acid ester and methacrylate or methacrylic acid ester. If the copolymers contain acrylic acid ester or methacrylic acid ester, the alcohol component of the ester is preferably selected from those which contain 1 to 6 C atoms. In particular methyl esters and ethyl esters may be used.

Specific examples of thermoplastics which may be used are block copolymers of styrene, butadiene and methacrylate, terpolymers of ethylene, butylacrylic acid ester and glycidyl methacrylic acid ester, terpolymers of ethylene, acrylic acid ester and maleic anhydride. In conjunction with the epoxy resins, these thermoplastics give rise, after curing thereof, to compounds which are hard and dimensionally stable up to 40° C. and are suitable for the production of bulk material. Furthermore, these terpolymers result in an only slight reduction in glass transition temperature, such that the substance mixtures according to the invention are very well suited for use in the automotive industry under test conditions of up to 80° C.

A large number of polyepoxides with at least two 1,2-epoxy groups per molecule are suitable as epoxy resins. The epoxy resins used for this purpose are those which, prior to their reaction with a curing agent, have a melting or softening point of at least 50° C., the softening point being determined in accordance with the product information from Dow Plastics (a business unit of Dow Chemical Company) using method RPM 108-C.

The epoxy equivalent of suitable polyepoxides may range between 150 and 50000, preferably between 170 and 5000. The polyepoxides may in principle be saturated, unsaturated, cyclic or acyclic, aliphatic, alicyclic, aromatic or heterocyclic polyepoxide compounds. Examples of suitable polyepoxides include those polyglycidyl ethers which are produced by reacting epichlorohydrin or epibromohydrin with a polyphenol in the presence of alkali. Examples of polyphenols which are suitable for this purpose are resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, 1,5-hydroxy-naphthalene. Further polyphenols suitable as the basis for the polyglycidyl ethers are known condensation products prepared from phenol and formaldehyde or acetaldehyde of the novolak resin type.

At least a proportion of the following polyepoxides may furthermore be used: polyglycidyl esters of polycarboxylic acids, for example reaction products of glycidol or epichlorohydrin with aliphatic or aromatic polycarboxylic acids such as oxalic acid, succinic acid, glutaric acid, terephthalic acid or dimer fatty acid.

An epoxy resin based on epichlorohydrin/bisphenol A which has an epoxide equivalent weight of 475 to 550 g/eq or an epoxy group content in the range from 1820 to 2110 mmol/g is, for example, suitable. The softening point determined to RPM 108-C is in the range from 75 to 85° C.

The binder compositions may optionally contain reactive diluents to adjust flow behavior. Reactive diluents for the purposes of the present invention are low viscosity substances containing epoxy groups (glycidyl ethers or glycidyl esters) with an aliphatic or aromatic structure. Typical examples of reactive diluents are mono-, di- or triglycidyl ethers of C₆ to C₁₄ monoalcohols or alkylphenols as well as the monoglycidyl ethers of cashew nut shell oil, diglycidyl ethers of ethylene glycol, diethylene glycol, triethylene glycol, tetraethylene glycol, propylene glycol, dipropylene glycol, tripropylene glycol, tetrapropylene glycol, 1,4-butylene glycols, 1,5-pentanediol, 1,6-hexanediol, cyclohexanedimethanol, triglycidyl ethers of trimethylolpropane and the glycidyl esters of C₆ to C₂₄ carboxylic acids or mixtures thereof.

The substance mixtures according to the invention are preferably curable and/or thermally expandable. They are then suitable for the above-described intended application of reinforcing or bracing hollow parts, in particular hollow parts in automotive construction.

Suitable blowing agents are in principle any known blowing agents such as for example “chemical blowing agents” which liberate gases on decomposition, or “physical blowing agents”, i.e. expanding hollow spheres. Examples of the first-stated blowing agents are azobisisobutyronitrile, azodicarbonamide, dinitrosopentamethylenetetramine, 4,4′-oxybis(benzenesulfonic acid hydrazide), diphenylsulfone-3,3′-disulfohydrazide, benzene-1,3-disulfohydrazide, p-toluenesulfonyl semicarbazide. Expandable hollow plastics microspheres based on polyvinylidene chloride copolymers or acrylonitrile/(meth)acrylate copolymers are particularly preferred. These are commercially available, for example, under the name “Dualite®” or “Expancel®” from Pierce & Stevens or Casco Nobel.

Thermally activatable or latent curing agents are used as the curing agents for the epoxy resin binder system. These may be selected from the following compounds: guanidines, substituted guanidines, substituted ureas, melamine resins, guanamine derivatives, cyclic tertiary amines, aromatic amines and/or mixtures thereof. The curing agents may here participate stoichiometrically in the curing reaction, but they may also be catalytically active. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and very particularly cyanoguanidine (dicyandiamide). Representative examples of suitable guanamine-derivatives which may be mentioned are alkylated benzoguanamine resins, benzoguanamine resins or methoxymethylethoxymethylbenzoguanamine. Dicyandiamide is preferably suitable.

Catalytically active substituted ureas may be used in addition to or instead of the above-stated curing agents. These are in particular p-chlorophenyl-N,N-dimethylurea (Monuron), 3-phenyl-1,1-dimethylurea (Fenuron) or 3,4-dichlorophenyl-N,N-dimethylurea (Diuron). Catalytically active tertiary acrylic amines or alkylamines, such as for example benzyldimethylamine, tris(dimethylamino)phenol, piperidine or piperidine derivatives may in principle also be used. Miscellaneous preferably solid imidazole derivatives may furthermore be used as catalytically active accelerators. 2-Ethyl-2-methylimidazole, N-butylimidazole, benzimidazole and N—C₁- to C₁₂-alkylimidazoles or N-arylimidazoles may be mentioned by way of example. Adducts of amino compounds onto epoxy resins are furthermore suitable as accelerating additions to the above-stated curing agents. Suitable amino compounds are tertiary aliphatic, aromatic or cyclic amines. Suitable epoxy compounds are for example polyepoxides based on glycidyl ethers of bisphenol A or F or of resorcinol. Specific examples of such adducts are adducts of tertiary amines such as 2-dimethyaminoethanol, N-substituted piperazines, N-substituted homopiperazines, N-substituted aminophenols, onto di- or polyglycidyl ethers of bisphenol A or F or of resorcinol.

The substance mixtures usable according to the invention generally furthermore contain per se known fillers, such as for example the various ground or precipitated chalks, carbon black, calcium-magnesium carbonates, talcum, barytes and in particular silicate fillers of the aluminum-magnesium-calcium silicate type, for example wollastonite, chlorite. Mica-containing fillers may preferably be co-used, it being very particularly preferred to use a “2-component” filler prepared from muscovite mica and quartz with a low heavy metal content.

In addition to the above-stated “normal” fillers, the substance mixture may contain “lightweight” fillers in order to reduce weight. These may be selected from the group of hollow metal spheres such as for example hollow steel spheres, hollow glass spheres, fly ash (Fillite), hollow plastics spheres based on phenolic resins, epoxy resins or polyesters, expandable hollow microspheres with a wall material of (meth)acrylic acid ester copolymers, polystyrene, styrene(meth)acrylate copolymers and in particular of polyvinylidene chloride and copolymers of vinylidene chloride with acrylonitrile and/or (meth)acrylic acid esters, ceramic hollow spheres, or organic lightweight fillers of natural origin such as ground nut shells, for example the shells of cashew nuts, coconuts or peanuts, and cork flour or coke powder. Particularly preferred lightweight fillers are those based on hollow microspheres which, in the fully cured molding matrix, ensure elevated compressive strength of the molding.

In a particularly preferred embodiment, the compositions for the thermally curable compounds additionally contain fibers based on aramid fibers, carbon fibers, metal fibers, for example of aluminum, glass fibers, polyamide fibers, polyethylene fibers or polyester fibers, these fibers preferably being pulp fibers or staple fibers which have a fiber length of between 0.5 and 6 mm have and a diameter of 5 to 20 μm. Polyamide fibers of the aramid fiber type or also polyester fibers are particularly preferred here.

A preferred substance mixture according to the present invention therefore contains:
a) at least one epoxy resin,
b) at least one thermoplastic selected from those copolymers which contain at least three different monomers,
c) at least one blowing agent,
d) at least one curing agent,
e) at least one filler,
   the above explanations applying with regard to components which are preferably to be selected.

The curable compounds to be used according to the invention may moreover contain further auxiliary substances and additives, such as for example plasticizers, reactive diluents, rheological auxiliaries, wetting agents, antioxidants, stabilizers and/or coloring pigments. The quantity ratios of the individual components may vary within relatively broad limits depending on the requirements profile in relation to processing characteristics, flexibility, required bracing action and adhesive bond to the substrates.

Typical ranges for the essential components are:

| | |
|---|---|
| epoxy resin | 2 to 70 wt. %, preferably 15 to 60 wt. %, |
| thermoplastic | 0.5 to 40 wt. %, preferably 5 to 30 wt. %, |
| reactive diluent | 0 to 15 wt. %, preferably 0 to 10 wt. %, |
| curing agent and accelerator | 1.5 to 5 wt. %, |
| blowing agent | 0.5 to 10 wt. %, |
| fillers (other than fibers) | 5 to 40 wt. %, |
| fibers | 0 to 30 wt. %, preferably 0.5 to 10 wt. %, |
| pigments | 0 to 1 wt. %, |

the total of all the components adding up to 100 wt. %.

The compositions according to the invention may readily be produced in granule form and may accordingly readily be stored and transported in conventional shipping containers, big bags, drums or sacks. They may be further processed in conventional injection molding installations without special supply, dispensing and conveying apparatus. The structural foams producible from these compositions have good characteristics on exposure to compressive or flexural loads which are comparable to those of hitherto known compositions based on epoxides. Surprisingly, despite good flow behavior in the injection molding machine, in the manufacturing sequence of the body-in-white during vehicle construction the compositions according to the invention do not exhibit any sagging or stripping in the cleaning and pretreatment baths at 65° C. with simultaneous exposure to flow conditions. Moreover, there is no observable tackiness of the moldings or granules at temperatures of below 45° C.

Thermally expandable moldings usable for bracing and/or reinforcing metallic components are preferably produced from the expandable, thermally curable compositions by injection molding at low pressures and low temperatures.

The present invention accordingly also relates to a method for producing moldings from a substance mixture as described above, the substance mixture being extruded with the assistance of an extruder through a die at a temperature in the range from 50 to 100° C. and, after cooling to a temperature of below 50° C., being chopped into pieces. In this manner, by extrusion through an appropriately shaped die and chopping to the desired length, it is possible to produce (preferably curable and thermally expandable) moldings whose shape is adapted to the shape of the cavity to be braced.

In this manner, a molding of a reactive compound which preferably crosslinks and is expandable by at least 20% at a temperature in the range from 120 to 220° C. is, for example, obtained. This preferably comprises at least one fastening element and/or at least one spacer with in each case a front and a reverse, which are defined in that the entire molding including the fastening element or the spacer is delimited by two parallel planar faces, the front of each fastening element or each spacer lying in one of the parallel faces and the reverse in the other of the parallel faces. It is used for reinforcing, insulating, damping and/or sealing hollow components. A more precise description of such a molding and details relating to the method for the production thereof may be found in German patent application DE 102007038659, which is not a prior publication.

The present invention furthermore relates to a method for producing moldings from a substance mixture as described above, the substance mixture being introduced with the assistance of an extruder at a temperature in the range from 50 to 100° C. into an injection mold and, after cooling to a temperature of below 50° C., being demolded.

Extrusion may here start from a substance mixture which is introduced as a premixed, but unshaped compound into the extruder or which is only mixed together from the individual raw materials in the extruder itself. It is, however, also possible, to use the substance mixture in the form of the above-described granules. This is then melted before introduction into the extruder or preferably in the extruder itself and pressed in this state into the injection mold.

This method variant is characterized by the following essential method steps:
a) mixing the previously described composition components at temperatures of below 100° C., preferably between 80 and 95° C.
b) extruding the composition at temperatures of below 100° C., preferably 80° C. to 95° C., optionally onto a chilled metal belt to form granules,
c) cooling the granules formed in this manner,
d) optional intermediate storage of the granules, preferably in transport containers, big-bags, drums or sacks,
e) conveying the granules into an injection molding machine,
f) melting the granules at temperatures of below 100° C. and injecting the melt into the predetermined mold of the injection molding machine,
g) cooling the molding formed and removing the molding from the mold.

The addition of thermoplastic(s) reduces the tackiness of the epoxy resin-containing compound to such an extent that there is no need to use a release agent for the extrusion or injection molding process.

The present invention furthermore encompasses an extruded or injection-molded molding which has been produced by the method according to the invention.

The main use of the moldings according to the invention is for bracing and reinforcing components, in particular components for white goods, or bodywork components such as body frames, doors, trunk lids, hoods and/or roof parts in automotive construction. The present invention accordingly also encompasses a vehicle or metallic component which has been braced or reinforced with at least one of the above-described moldings obtained by extrusion, in particular by contour extrusion, or by injection molding.

In particular, the present invention encompasses a method for reinforcing, insulating, damping and/or sealing hollow components, in which, prior to manufacture of the hollow component, a molding obtained according to the invention is fastened to an internal wall of the hollow component, the hollow component is closed and heated to a temperature in the range from 120 to 220° C., preferably for a period of time in the range from 10 to 150 minutes.

This method is carried out using the conventional production process for elongate hollow structures in vehicle construction, for example for the frame which surrounds the passenger cell. These hollow structures are conventionally manufactured by producing two correspondingly shaped half-shells from metal and assembling these half-shells to form the hollow frame structure or a part thereof. Such hollow structures or hollow beams are for example the A, B or C column of an automotive body which bear the roof structure, or also roof rails, sills and wheel arch or engine mounting parts. As is usual when “pillar fillers” or “baffles” are used in such hollow structures in the prior art, the molding obtained according to the invention may be fastened with the assistance of a fastening element or a tacky surface portion to the surface of the half-shell which will subsequently become the internal wall of the cavity, before said half-shell is assembled with the other half-shell to form the hollow structure.

The molding obtained according to the invention is here preferably shaped such that, viewed perpendicularly to its longitudinal axis, its cross-section corresponds to the cross-sectional shape of the cavity. The molding is, however, dimensioned such that, prior to foaming, it is in contact at only one or a few points with the internal wall of the hollow part. Apart from these points, between the defining faces extending parallel to the longitudinal axis of the molding and the internal walls of the hollow part there remains a flooding gap of a width of around 1 to around 10 mm, preferably of around 2 to around 4 mm. This flooding gap ensures that the various process liquids with which the body shell is treated are able to wet all parts of the inner sides of the cavity walls. The flooding gap is not closed until the molding is thermally expanded, whereby the latter performs its intended purpose of reinforcing, insulating, damping and/or sealing the hollow components. Spacers on the moldings may ensure that this flooding gap is reliably obtained before the molding is foamed and is maintained until foaming.

### EXAMPLES

The following table (Table 1) contains substance mixtures according to the invention as Examples 1 to 3 together with comparison substance mixtures 1 to 3 (Comparative Examples). The quantities are stated as weight percentages relative to the entire composition. The epoxy resin used was an epoxy resin solid at 20° C. with a softening point in the range from 75 to 85° C. according to method RPM 108-C The epoxy equivalent weight is in the range from 475 to 550 g/eq.

SBS and EVA are thermoplastics used for comparison which do not give rise to an adequate effect according to the invention. “Terpolymer” and “block polymer” denote thermoplastics to be used according to the invention which give rise to the desired results. In the exemplary embodiments, the terpolymer used was firstly a terpolymer of ethylene, methyl acrylate and glycidyl methacrylate or a terpolymer of ethylene/acrylic acid ester and maleic anhydride, which give rise to comparable results. The block polymer used was a styrene/butadiene/methacrylate polymer.

The individual raw materials were mixed with one another in a twin screw extruder. In a first step, epoxy resin, thermoplastic and fillers were added, followed by glass fibers and hollow glass spheres and in a final step the reactive components (curing agent, accelerator, blowing agent). The following parameters were set for the injection molding tests:

Cylinder and screw temperature: 90° C.;
Feed rate: 25 m/min;
Back pressure: 10 bar;
Feed volume, spiral/blade: 80 cm³/8 cm³;
Injection pressure: 400 bar;
Injection time: 4 sec.;
Injection mold temperature: 15° C.;
Cooling time: 10 sec.

The resultant injection molded parts were assessed with regard to their tackiness at 40° C. and 70° C., their hardness at 40° C. and their injection moldability on a rating scale from 0 to 5. Higher ratings mean better applicational properties. A rating of at least 3 is considered acceptable. As the table shows, the compositions according to the invention achieve a rating of at least 3 for all the assessed criteria, while the comparison compositions achieve a rating of 2 or worse for at least one criterion.

TABLE 1

| | Comp. | Comp. | Example | Example | Example | Comp. |
|---|---|---|---|---|---|---|
| | Example 2 | Example 3 | 1 | 2 | 3 | Example 1 |
| | in % | in % | in % | in % | in % | in % |
| Raw material | | | | | | |
| Epoxy resin | 40.00 | 40.00 | 40.00 | 40.00 | 50.00 | 60.00 |
| SBS | 20.00 | 0.00 | 0.00 | 0.00 | 0.00 | 0.00 |
| EVA | 0.00 | 20.00 | 0.00 | 0.00 | 0.00 | 0.00 |
| Terpolymer | 0.00 | 0.00 | 20.00 | 0.00 | 10.00 | 0.00 |
| Block polymer | 0.00 | 0.00 | 0.00 | 20.00 | 0.00 | 0.00 |
| Glass fiber | 5.00 | 5.00 | 5.00 | 5.00 | 5.00 | 5.00 |
| Hollow glass spheres | 15.00 | 15.00 | 15.00 | 15.00 | 15.00 | 15.00 |
| Silicate filler | 7.00 | 7.00 | 7.00 | 7.00 | 7.00 | 7.00 |
| Calcium carbonate | 7.90 | 7.90 | 7.90 | 7.90 | 7.90 | 7.90 |
| Pigment | 0.10 | 0.10 | 0.10 | 0.10 | 0.10 | 0.10 |
| Expandable hollow plastics | 2.30 | 2.30 | 2.30 | 2.30 | 2.30 | 2.30 |
| microspheres | | | | | | |
| Epoxy resin/amine | 0.60 | 0.60 | 0.60 | 0.60 | 0.60 | 0.60 |
| adduct | | | | | | |
| Dicyandiamide | 2.10 | 2.10 | 2.10 | 2.10 | 2.10 | 2.10 |
| | 100.00 | 100.00 | 100.00 | 100.00 | 100.00 | 100.00 |
| Properties: | | | | | | |
| Tackiness at 40° C. | 5 | 4 | 5 | 4 | 4 | 4 |
| Tackiness at 70° C. | 4 | 2 | 5 | 4 | 4 | 1 |
| Hardness at 40° C. | 5 | 2 | 4 | 3 | 4 | 4 |
| Injection moldability | 1 | 5 | 4 | 3 | 3 | 1 |

| | | | |
|---|---|---|---|
| Tackiness rating: | Scale from 0-5 | 0 = very tacky | 5 = not tacky |
| Hardness rating: | Scale from 0-5 | 0 = very hard | 5 = very soft |
| Injection moldability rating: | Scale from 0-5 | 0 = very poor | 5 = very good |

What is claimed is:

1. A method of reinforcing, insulating, damping and/or sealing an automotive component comprising steps of:
placing an extruded or injection-molded molding in a hollow automotive component, optionally fastening the molding to an internal wall of the hollow component, wherein the molding comprises a substance mixture containing a polymer blend which comprises:
at least one epoxy resin and
one or more thermoplastics, said thermoplastics being selected from copolymers comprising at least three different monomers, and wherein proportion by weight of said thermoplastics in the substance mixture is in a range from 0.5 to 40 wt. %; and
curing and/or thermally expanding the substance mixture.

2. The method according to claim 1, wherein the copolymers comprising at least three different monomers are selected from copolymers in which
at least one monomer is a hydrocarbon without heteroatoms and with at least one C═C double bond and
at least one other monomer is an optionally substituted acrylate or an optionally substituted acrylic acid ester.

3. The method according to claim 2, wherein the one or more thermoplastics are selected from random copolymers or block copolymers selected from the group consisting of: styrene/butadiene/(meth)acrylate, styrene/butadiene/(meth)acrylic acid ester, ethylene/(meth)acrylic acid ester/glycidyl(meth)acrylic acid ester, ethylene/(meth)acrylic acid ester/maleic anhydride.

4. The method according to claim 1, wherein the substance mixture additionally comprises a curing agent for the epoxy resin and/or a blowing agent.

5. The method according to claim 1, wherein the substance mixture further comprises:
at least one blowing agent,
at least one curing agent,
at least one filler.

6. The method according to claim 1, wherein the substance mixture comprises:
a) 2 to 70 wt. % of the at least one epoxy resin,
b) 0.5 to 40 wt. % of the at least one thermoplastic selected from copolymers which contain at least three different monomers,
c) 0.5 to 10 wt. % of at least one blowing agent,
d) 1.5 to 5 wt. % of at least one curing agent,
e) 5 to 40 wt. % of at least one filler,
f) 0 to 30 wt. % fibers,
g) 0 to 1 wt. % pigments, and
h) 0 to 15 wt. % reactive diluent;
wherein a) to h) sum to 100 wt. %.

7. The method according to claim 1, wherein the moldings are produced by:
extruding the substance mixture at a temperature in a range from 50° C. to 100° C. through a die to form an extrusion,
cooling the extrusion to a temperature of below 50° C., and
cutting said extrusion into pieces.

8. The method according to claim 1, wherein the moldings are produced by:
introducing, optionally via an extruder, the substance mixture at a temperature in the range from 50° C. to 100° C. into an injection mold to form a molded substance mixture,
cooling the molded substance mixture to a temperature of below 50° C., and
demolding.

9. The method according to according to claim 1, wherein, prior to the curing and/or thermally expanding step, the at least one epoxy resin has a melting or softening point of at least 50° C.

10. A vehicle or component reinforced, insulated, damped and/or sealed according to the method of claim 1.

11. A method of reinforcing, insulating, damping and/or sealing hollow components, wherein, prior to manufacture of a hollow component, a molding is fastened to an internal wall of the hollow component, the hollow component is closed and heated to a temperature in a range from 120 to 220° C., for a period of time in a range from 10 to 150 minutes, wherein said molding comprises a substance mixture containing a blowing agent and a polymer blend which comprises: at least one epoxy resin and one or more thermoplastics, said thermoplastics being selected from copolymers comprising at least three different monomers, and wherein proportion by weight of said thermoplastics in the substance mixture is in a range from 0.5 to 40 wt. %.

12. An article of manufacture comprising:
a foamable, extruded or injection-molded molding comprising a substance mixture containing:
a blowing agent and
a polymer blend which comprises:
at least one epoxy resin and
one or more thermoplastics selected from
terpolymers of ethylene, butylacrylic acid ester and glycidyl methacrylic acid ester, and
terpolymers of ethylene, acrylic acid ester and maleic anhydride,
wherein proportion by weight of said one or more thermoplastics in the substance mixture is in a range from 0.5 to 40 wt. %.

13. The article according to claim 12, wherein the substance mixture further comprises fibers based on aramid fibers, carbon fibers, metal fibers, glass fibers, polyamide fibers, polyethylene fibers or polyester fibers.

14. The article according to claim 12, wherein the substance mixture further comprises:
at least one curing agent,
at least one filler.

15. The article according to claim 12, wherein the substance mixture comprises:
a) 2 to 70 wt. % of the at least one epoxy resin,
b) 5.0 to 30 wt. % of said one or more thermoplastics,
c) 0.5 to 10 wt. % of the at least one blowing agent,
d) 1.5 to 5 wt. % of at least one curing agent,
e) 5 to 40 wt. % of at least one filler,
f) 0 to 30 wt. % fibers,
g) 0 to 1 wt. % pigments, and
h) 0 to 15 wt. % reactive diluent;
wherein a) to h) sum to 100 wt. %.

16. The article according to claim 12, wherein the molding is produced according to a process comprising:
introducing, optionally via an extruder, the substance mixture at a temperature in the range from 50° C. to 100° C. into an injection mold to form a molded substance mixture,
cooling the molded substance mixture to a temperature of below 50° C., and
demolding;
wherein the molding is produced in the absence of a release agent.
